(19) United States
(12) Patent Application Publication
(10) Pub. No.: US 2002/0073712 A1
(43) Pub. Date: Jun. 20, 2002

(54) Subatmospheric gas-turbine engine

(76) Inventor: William L. Kopko, Springfield, VA (US)

Correspondence Address: William L. Kopko, 8705 Cromwell Drive, Springfield, VA, 22151, US

(21) Appl. No.: 09/977,965

(22) Filed: Oct. 17, 2001

Related U.S. Application Data
(60) Provisional application No. 60/241,350, filed on Oct. 19, 2000.

(51) Int. Cl. F02C 6/18

(52) U.S. Cl. 60/775; 60/39.181

(57) ABSTRACT

A gas-turbine engine with a subatmospheric operating pressure that is suitable for bottoming cycles and topping cycles with conventional power plants. A hot-gas stream expands through a turbine to a pressure below atmospheric. The resulting low-pressure gas stream is cooled to a lower temperature and then pressurized through a compressor. The cooling can be accomplished by the addition of a water fog to the air stream. The pressurized air stream exiting the compressor may be exhausted to the atmosphere. The compressor and turbine may share a common shaft a drive a generator to produce an electrical output. Another option is a pressure output; the compressor outlet pressure may be higher than the turbine inlet pressure so as to act as pump. Other embodiments drive a supercharging fan for a conventional combustion turbine. A topping cycle embodiment uses a high-temperature heat exchanger with low pressure differential and is suitable for use with coal and other solid fuels. Ozone may be added to the hot gas stream to convert nitrogen and sulfur oxides into water-soluble compounds that may be removed with a water fog.

The applicant claims benefit of U.S. provisional application number 60/241,350, entitled “Subatmospheric gas-turbine engine,” filed on Oct. 19, 2000.

### BACKGROUND-FIELD OF INVENTION

This invention is related to the field of gas-turbine engines, specifically a gas-turbine engine with subatmospheric operating pressure.

### BACKGROUND-DESCRIPTION OF THE PRIOR ART

A fundamental approach to all engines that use gas as working fluid is compression followed by heating (usually from combustion) and then expansion. This sequence is common to all gas turbines and internal-combustion engines now in use.

FIG. 1 is a schematic drawing of modern combined-cycle plant, which is a combination of a gas turbine and steam bottoming cycle. The gas turbine is basically an open Brayton cycle. A compressor pressurizes air and supplies it to a flame that heats the pressurized air, which then expands through an expander to produce work. This cycle serves as the basis of modern gas turbines.

The steam cycle recovers heat from the gas-turbine exhaust in a recovery boiler to produce high-pressure steam in a closed Rankin cycle. A condenser, which is typically cooled with water from a wet cooling tower, removes heat from the cycle. FIG. 1 shows a simple one-pressure cycle. Cycles with multiple pressures are also common and can increase performance but with added expense and complexity.

The combined-cycle plant has the advantage of high efficiency, but has disadvantages of relatively high cost, large size, and complexity. The steam portion of the plant typically supplies output equal to about half of the output of the gas turbine, but costs roughly twice as much. The size of the heat recovery boiler is also quite large compared to that for a gas turbine. Additional space is required for the condenser and related cooling towers along with the steam turbines and pumps. All this equipment combines to give a complex system. Numerous variations of combined-cycle and simple-cycle plants appear in standard reference texts such as Rolf Kehlhoffer, Combined Cycle Gas & Steam Turbine Power Plants and William Bathie, Fundamentals of Gas Turbines.

A variation of the cycle for gas turbines is closed-cycle gas turbine. (See for example Bathie, p 168-170 for a description of this cycle.) The closed-cycle turbine uses heat exchangers to heat the gas after compression and cooling it after expansion through the turbine. The chief advantage of this system is that it can use coal or other solid fuel without contaminating the gas stream entering the expander. These systems can use different gases such as helium or nitrogen in addition to air. An important claimed advantage of these systems is that they can operate at a compressor inlet pressure that is well above atmospheric pressure, which reduces the size of the components for a given capacity.

The chief disadvantages of closed-cycle systems are the cost and size associated with the heat exchangers. The heat-exchanger materials also impose a temperature limit, which further reduces performance. Since the strength of the high-temperature materials goes down with temperature, the high operating pressures associated with conventional closed cycle systems further limits the operating temperatures and adds to the cost of the system.

FIG. 2 shows a curious machine, called an “atmospheric engine,” that works on a much different principle. Heated gases from the flame enter the cylinder through a valve as a piston moves downward from the top of its stroke inside a cylinder. Near the bottom of the stroke, the valve closes, which prevents the flame from entering the cylinder. The gas inside the cylinder gradually cools, which reduces the pressure of the gas to create a partial vacuum. Atmospheric pressure drives the piston upward and compresses the cooled gas back to atmospheric pressure.

Variations of these engines were used before the introduction of the Otto cycle in the 1870's. An important advantage of the engines was the low operating pressure greatly reduced the risks from explosions, which were a common occurrence at the time.

By modem standards these engines had very poor operating efficiency and power output. The engines relied on heat transfer through the thick cylinder walls to cool the gas, which limited the speed of operation. The low operating pressures and high friction losses of the machine further reduced performance. These disadvantages led to the complete abandonment of the concept of the atmospheric engine with the introduction of more-modem engine designs by the end of the 1800's.

Modem literature generally ignores the atmospheric engine or treats it as a historical curiosity that is of no use in modem engine design. For example, Heywood devotes only two sentences on these engines at the beginning of his standard reference book, Internal Combustion Engine Fundamentals. The How and Why of Mechanical Movements by Henry Walton, a Popular Science Book from the 1960's, describes atmospheric engines in its chapter on the history of the internal-combustion engine under a heading of “Detours and Blind Alleys.” The conventional wisdom is that compression followed by heating with operating pressures staying at or above atmospheric is the only practical way to design a modem gas engine.

### SUMMARY

In accordance with the present invention a gas-turbine engine comprises an expander that expands a hot-gas stream to a subatmospheric pressure, means for cooling the low-pressure gas stream from the expander, and a compressor for pressurizing the gas stream.

Objectives and Advantages

1) provide a bottoming cycle that does not need a heat exchanger

2) high efficiency

3) low installed cost

4) low operating cost

5) small size

6) easy addition of a bottoming cycle to existing power plants

7) ability to enhance capacity of existing power plants

8) inexpensive materials of construction

9) reduced operating speed and pressures for small turbines

10) reduced emissions of atmospheric pollutants such as NOₓ, SOₓ

11) topping cycle for improved efficiency of plants using solid fuel

12) additional capacity from existing plants.

### DRAWING FIGURES

FIG. 1 shows combined-cycle power plant found in the prior art.

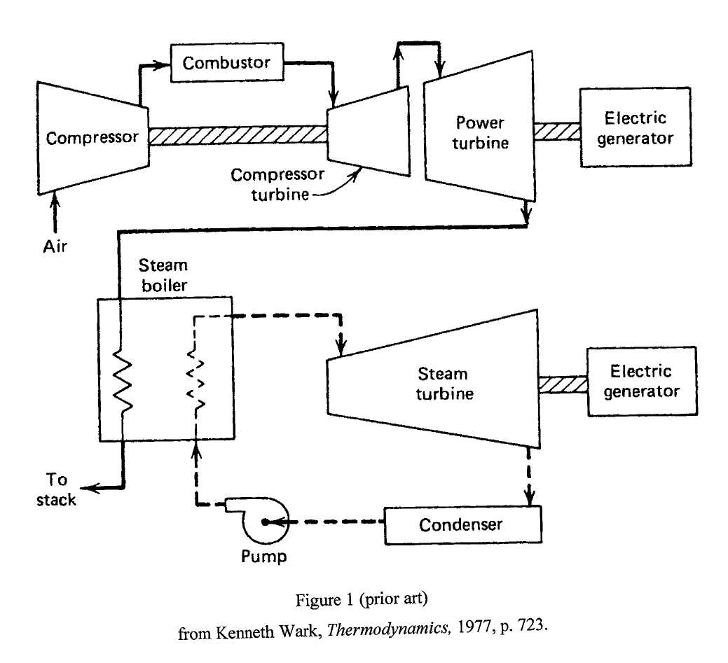

FIG. 2 shows an externally fired atmospheric engine found in nineteenth-century prior art.

FIG. 3 is a preferred embodiment of the invention that is suitable for use as bottoming cycle for a gas turbine power plant.

FIG. 4 is a second preferred embodiment that integrates the invention into a gas-turbine power plant.

FIG. 5 is an embodiment that includes a regenerator and an external combustor.

FIG. 6 is an embodiment that acts to increase the output and efficiency of a simple-cycle turbine.

FIG. 7 shows another embodiment for enhancing output of a simple-cycle turbine.

FIG. 8 is an embodiment that includes a supercharging fan.

FIG. 9 is a preferred embodiment with a variable-speed supercharging fan.

FIG. 10 shows an embodiment with a steam-injected gas turbine.

FIG. 11 shows an embodiment with dry heat exchangers that is suitable for locations with limited water availability.

FIG. 12 shows a closed-cycle embodiment suitable for use with a solid fuel such as coal or wood.

FIG. 13 shows a preferred embodiment for use as a topping cycle with a solid-fuel heat input.

FIGS. 14A and 14B show how a topping cycle can be added to an existing coal-fired boiler.

FIG. 15 is a pressure-volume diagram for an idealized cycle.

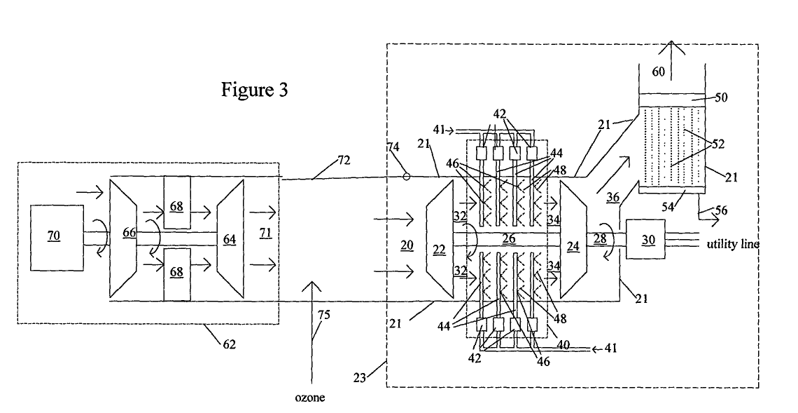

### DESCRIPTION—FIGURE 3—PREFERRED EMBODIMENT

FIG. 3 shows a preferred embodiment of the invention that forms a bottoming cycle 23. A hot gas stream 20 enters an expander 22 that is attached to a shaft 26. The expander is preferably a one-stage or two-stage axial expander. A compressor 24 is also attached to the shaft 26. The compressor is preferably a single-stage centrifugal compressor or a multistage axial compressor. An output shaft 28 drives a generator 30 that supplies three-phase power to a utility line. A duct 21 encloses the expander and compressor and directs gas through the system.

The expander 22 expands the hot gas stream to a lower, subatmospheric pressure to form a low-pressure gas stream 32. The low-pressure gas stream 32 goes through a fogger 40, which sprays a fine water mist to reduce the temperature and humidify the gas to form a cooled low-pressure air stream 34.

The fogger comprises a source of water 41, which is connected to pumps 42 that supply high-pressure water to headers 46. The headers have nozzles 46 that produce a fine spray 48. The pressure from the pumps is preferably about 1000 to 3000 psi. The water is preferably softened, filtered water to prevent clogging of the nozzles and build up of minerals.

The cooled low-pressure gas stream 34 enters compressor 24 which pressurized the gas to form a compressed gas stream 36. The amount of water mist from the fogger is preferably somewhat greater than that necessary to saturate the compressed gas stream leaving the compressor, which reduces the gas temperature and required compressor work. A mist eliminator 50 coalesces water droplets from the gas and an exhaust stream 60 is vented to the atmosphere. Water drops 52 fall from the mist eliminator and collect in a pool 54 and leave as a discharge water stream 56.

As shown in FIG. 3 the hot gas stream 20 is an exhaust stream 71 from a combustion turbine 62, but a number of other alternatives are possible such as waste heat from an internal-combustion engine, gas heated by a burner or flame, or heat from solar energy or geothermal energy. The combustion turbine 62 comprises a combustor 68 and an expander 64 connected by a shaft to a compressor 66 and a generator 70. The combustion turbine may be of conventional design. The pressure of the hot-gas stream is normally near atmospheric but it can be at a higher or lower pressure depending on the relative sizing of the components.

A damper 72 that pivots about hinge 74 is located between the combustion turbine outlet and the inlet to expander 22. As shown in the figure the damper allows exhaust from the combustion turbine to flow into expander 22. When the damper rotates counterclockwise about the hinge, it diverts the exhaust stream away from the expander 22 and exhausts it to the atmosphere. This feature allows the combustion turbine to run without the bottoming cycle 23.

One important advantage over water-injection or steam-injection systems for turbines in the prior art is that the use of demineralized water is not normally required. In the prior art, water injection comes upstream of combustion, which means that the water is completely evaporated and leaves behind any dissolved salts. These salts would coat turbine blades and combustor components and cause problems with fouling and corrosion. In the present invention, on the other hand, water is injected after combustion. This configuration means that an amount of water in excess of what is necessary to saturate the exhaust air steam may be injected. Dissolved salts are simply carried away in the discharge water stream. The main requirements are that the water is sufficiently soft and free of suspended particles to prevent clogging of fogger nozzles and to prevent precipitation of calcium salts or other minerals on compressor blades.

The preferred embodiment in FIG. 3 can significantly reduce atmospheric emissions from a combustion turbine. The embodiment includes an ozone injection system 75, which is supplies ozone to the hot gas stream 20. This ozone injection system oxidizes NO and NO₂ to form N₂O₃ and N₂O₅. Suitable ozone injection systems are found in the prior art and include those sold by BOC Gases.

The nitrogen and sulfur oxides would tend to concentrate in the water droplets produced by the fogger in the form of acids. These acids would be disposed of in the discharge water stream. The addition of a buffering material, such as calcium carbonate or sodium bicarbonate, may be used to neutralize acids in the discharge water to provide an acceptable pH before discharge. The buffering material can also be added to the water before it enters the foggers. The discharge water may be released to municipal sewers, used as irrigation water, evaporated in a pond, or disposed of in some other manner.

One advantage of this embodiment it the ability to use readily available, low-cost, materials without the need for sophisticated cooling systems found in modem gas turbines. For example, a typical exhaust temperature from a gas turbine is on the order of 1000 to 1200° F., which is within the capabilities of alloy steels, nickel-cobalt alloys, and other materials without blade cooling.

The fogger cools the gas to a much lower temperature that approaches the wet-bulb temperature of the air stream, which is typically about 130° F. This low temperature means that resistance to high temperature is not a factor the selection of compressor materials. The compressor blades can be constructed of steel, aluminum, or even plastic materials. An important consideration in the selection of compressor materials would be resistance to erosion and corrosion associated with moisture and acids along with the normal considerations of cost, strength, weight, etc. Plastic coatings or other corrosion-resistant finishes may be desirable, depending on the compatibility of the blade material with the wet gas stream.

While the preferred configuration injects sufficient fog for saturation of the compressor outlet, it may be desirable to reduce the amount of water mist entering the compressor in some cases. Less mist would reduce potential problems with blade erosion that may occur depending on the droplet sizes, material properties, geometry of the compressor, and other factors. If saturation were not achieved on the compressor outlet, then it would be desirable to use demineralized water or periodically clean the compressor blades to reduce build up of minerals left by the evaporating water.

The high gas volumes and low pressure ratio of the present invention may favor a slower rotational speed for the compressor and expander than found in conventional designs. Conventional turbines normally run at two-pole synchronous speed (3600 rpm at 60 Hz) or higher. With the present invention it may be desirable to reduce this speed to 1800 rpm (four-pole speed at 60 Hz) or lower for a large system. For small systems it may be possible to run with direct drive at 3600 rpm and eliminate the need for speed-reduction gears. This change would reduce the strength requirements of the compressor and turbine blades. It should also reduce any potential problems associated with impact damage from water droplets hitting the compressor blades.

While the expander and compressors are preferably axial-flow, kinetic devices; other types of machines are possible. For example, centrifugal turbines and compressors or positive-displacement machines, such as screw or reciprocating expanders and compressors are also possible and may have advantages in small-capacity systems. One important limitation is that the efficiencies of these devices must be high in order to get useful work from the system.

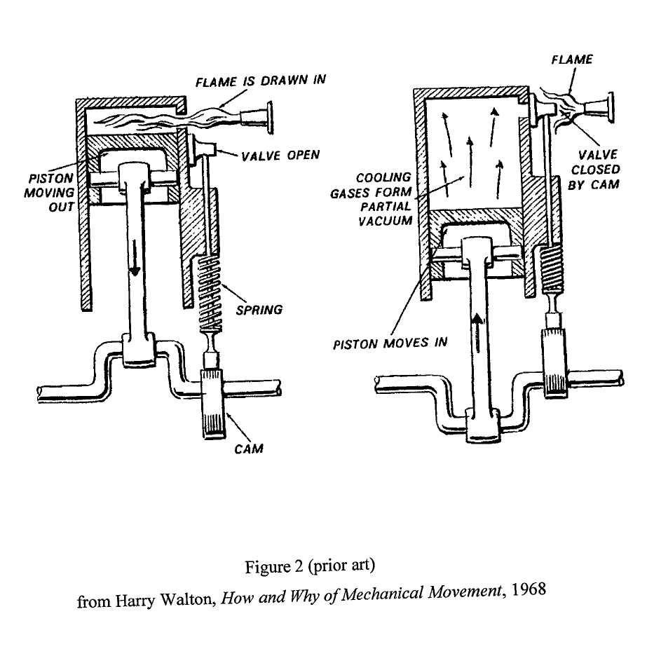

The use of evaporation of water for cooling a gas as a part of the engine in itself is a new improvement on older “atmospheric” engines that used conduction through thick cylinder walls for cooling. While not preferred, the basic thermodynamic cycle of the engine can be incorporated into a reciprocating engine similar to that of FIG. 2 with the addition of a means for injecting a mist of water or other volatile liquid into the engine cylinder near the end of the piston's downstroke. This provision should improve the efficiency and capacity of such an engine by better cooling the gas in the cylinder before the compression stroke.

The operating pressures and pressure ratios for the embodiment in FIG. 3 are low and should not represent a challenge in the design of the expander or compressor. The optimum pressure ratio in terms of maximizing output per unit of flow volume is on the order of 3 for this system, which is preferably handled by a single-stage centrifugal compressor and a one-stage axial expander. The corresponding pressure for the low-pressure gas stream is about 5 psia. Somewhat higher pressure ratios may be desirable to improve the efficiency of the system, but the pressure ratios are still much smaller than those found in conventional gas turbines. These low pressures and pressure ratios, combined with the use of inexpensive materials and lack of specialized cooling systems greatly reduce the cost of the system compared to conventional gas turbines.

While not shown in FIG. 3, the system would normally include inlet air filters, silencers, controls, etc. as is normal for system in the prior art.

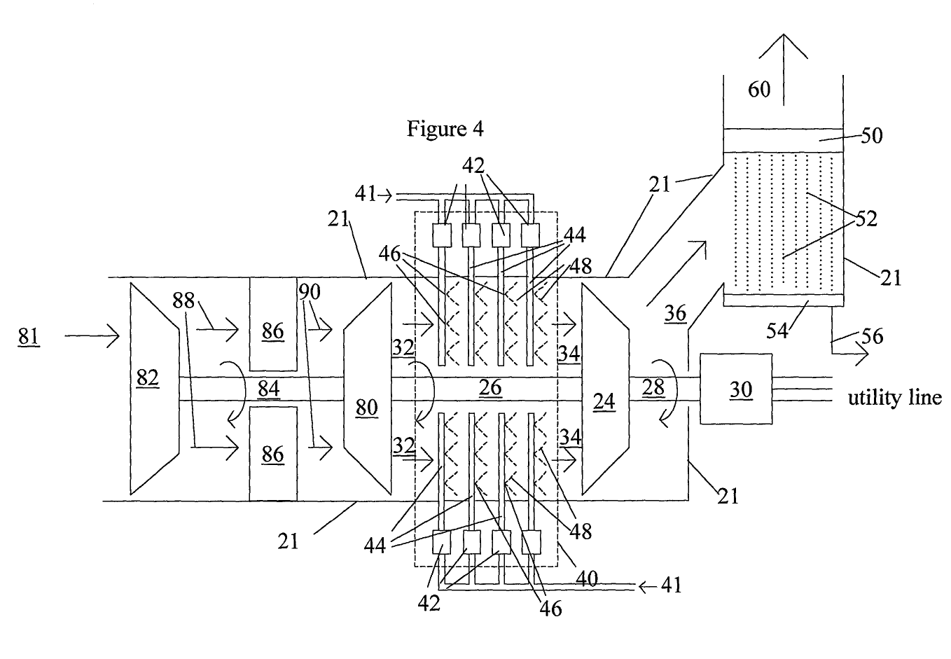

FIG. 4—Embodiment That is Integrated Into a Combustion Turbine

FIG. 4 shows a similar embodiment. The chief difference from FIG. 3 is that the bottoming cycle is combined with the combustion turbine into a single system. Specifically shaft 26 is connected to expander 80 and compressor 24. The expander 80 is connected by way of a shaft 84 to a second compressor 82. The second compressor draws air from the atmosphere 81 and supplies a pressurized air stream 88 to a combustor 86. The combustor 86 heats the air to produce a heated pressurized air stream 90, which flows through the expander 80. The output of the expander is the low-pressure air stream 32. The downstream components are the same as those described for FIG. 3.

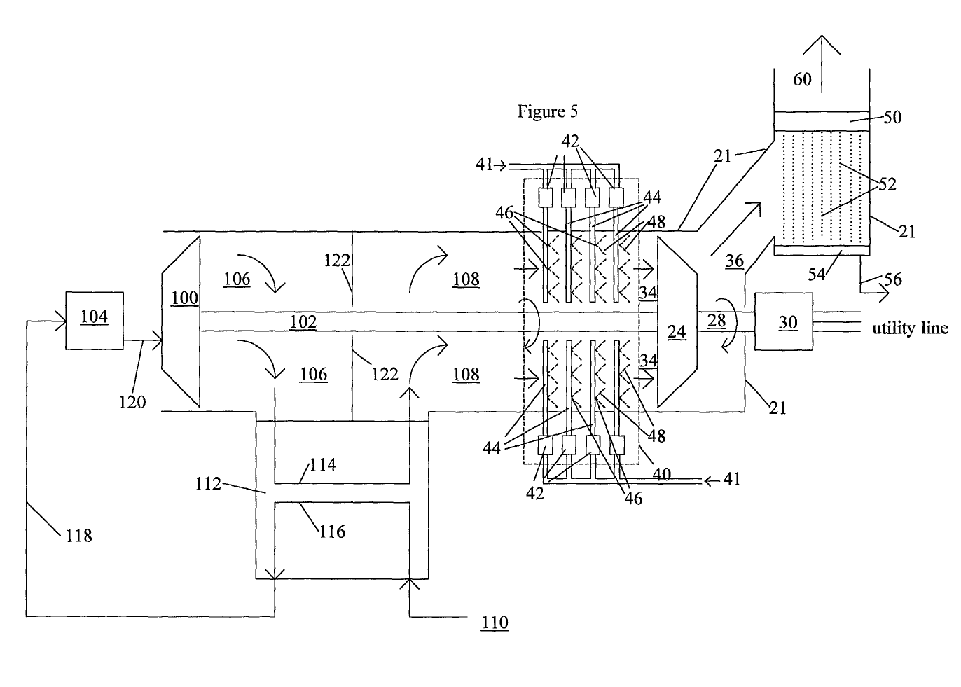

FIG. 5—Stand-Alone Embodiment With Regenerator

FIG. 5 shows a regenerative embodiment of the invention. Air is drawn from the atmosphere 110 to form an air stream 116 that is heated in a heat exchanger 112 to form a heated air stream 118. The heated air stream 118 enters a combustor 104, which further heats the air to form a turbine inlet air stream 120 that then flows through expander 100. The expander 100 expands the air stream 106 and extracts work in the process and is connected by way of shaft 102 to compressor 24. The air leaving the expander 100 is a hot low-pressure gas stream 106. A baffle 122 directs the air into the heat exchanger 112 as a low-pressure gas stream 114 and exits as a warm low-pressure air stream 108. The warm low-pressure gas stream 108 leaving the heat exchanger 112 is further cooled by the fogger 44, which is described for FIG. 3 along with the other downstream components.

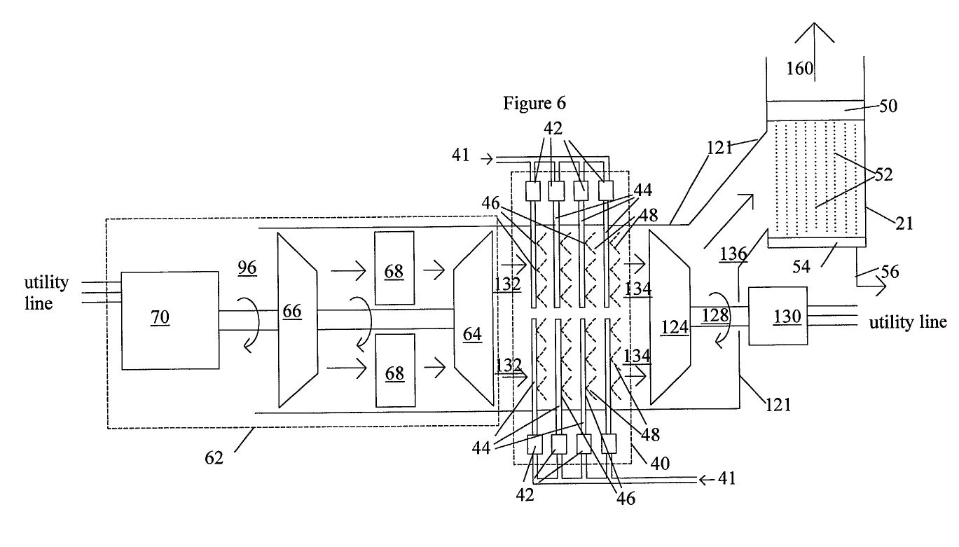

FIG. 6—Embodiment With Motor-Driven Compressor

FIG. 6 shows an alternate embodiment for enhancing the output of a conventional turbine using a motor-driven compressor. The combustion turbine 62 is of conventional design as described earlier for the embodiment in FIG. 3. A hot gas stream 132 from exhaust of the combustion turbine enters the fogger 40, which is also described earlier in the embodiment in FIG. 3. The fogger cools and humidifies the air to create a cooled low-pressure air stream 134 that enters a motor-driven compressor 124. A motor 130 drives the compressor by way of a shaft 128. The motor-driven compressor raises the pressure of the air to level near atmospheric to create a compressed gas stream 136. The mist eliminator, which is described for FIG. 3, removes water droplets from the compressed gas stream to create an exhaust gas stream. A housing 121 surrounds compressors and expanders and directs air through the system.

Preferred operating pressures for the compressor 124 depend on the characteristics of the combustion turbine. For a typical combustion turbine, the capacity increases approximate 0.2% per inch of water of outlet pressure reduction. A 20% increase in capacity of the combustion turbine would correspond to approximately 100inches of water pressure reduction. This pressure reduction is about 0.25 atmospheres, which means that the corresponding compressor pressure ratio is about 1.33.

A 20% increase in turbine output is consistent with the available generator capacity that is typically available at high inlet air temperature to the combustion turbine. This setup means that it is possible to add the motor-driven compressor 124 and associated components to an existing combustion turbine without replacing the generator or other components. A bypass damper similar to that shown in FIG. 3 may be added to allow operation of the combustion turbine without running the motor-driven compressor 124.

The motor-driven compressor 124 preferably includes a means for varying capacity. At high ambient temperatures the compressor would run at full capacity. At lower temperatures, the compressor capacity is reduced to ensure the capacity of the generator or other critical components are not exceeded. Capacity control means may include variable inlet vanes, variable-speed drives, variable-pitch blades, or similar devices. Control of the compressor capacity can be handled using a central controller that also regulates output of the combustion turbine, or it can be a simple stand-alone system.

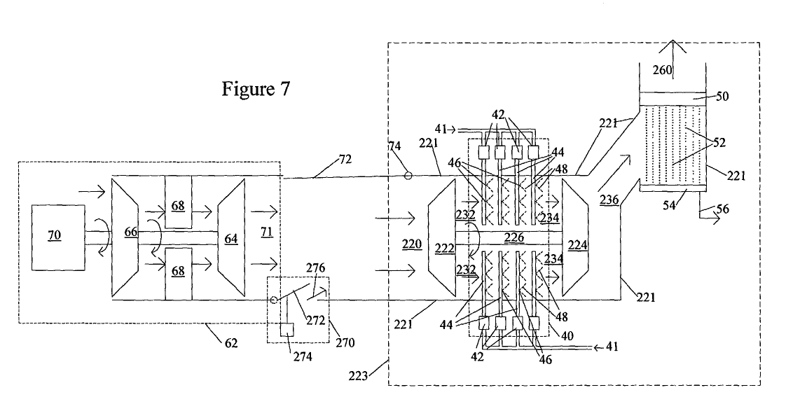

FIG. 7—Exhaust-Gas Pumping Embodiment

While the preferred embodiment of the invention would normally include a generator or other shaft output, the output shaft is optional. FIG. 7 is an example of an embodiment that does not have a shaft output. This embodiment raises the pressure of the gas stream instead of providing electrical output directly. As shown in FIG. 7, the system may be placed on the exhaust of the combustion turbine 62 and thereby reduce the exhaust pressure below atmospheric pressure. This approach has the advantage of eliminating the need for a separate generator.

The exhaust 71 from the combustion turbine 62 mixes with a control air stream 276 to form a hot gas stream 220, which enters an exhaust pumping system 223. The bypass air stream 276 is supplied through a control valve 270 that comprises a damper 272 that is connected to an actuator 274. With the control valve closed, the pumping system 223 reduces the pressure of the exhaust stream 71 to a minimum value, which increases the output of the combustion turbine 62. Opening the control valve raises the pressure of the exhaust stream 71 and reduces the available capacity of the combustion turbine 62. The operation of this control valve is preferably controlled so as to maintain a constant output power over a range of ambient temperatures. As in the embodiment in FIG. 3, the damper 72 allows operation of the combustion turbine without operation of the exhaust pumping system 223.

The pumping system 223 comprises an expander 222 and a compressor 224 that are connected to a shaft 226. As with other embodiments, the hot gas stream 220 flows through the expander to produce a low-pressure gas stream 232, which is cooled by the fogger 40 to produce a cooled low-pressure gas stream 234. The cooled low-pressure gas stream enters the compressor 224, which raises the pressure to create a pressurized gas stream 236, which is at nearly atmospheric pressure. The mist eliminator 50 removes excess water from the gas stream, which then exits as an exhaust stream 260. A housing 221 acts as a duct to direct gas through the expander and the compressor and other components.

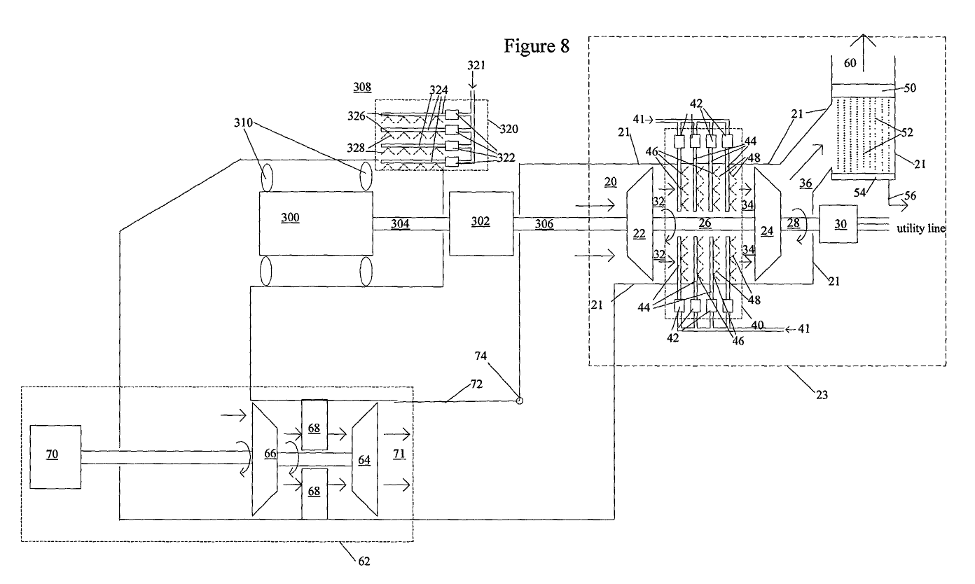

FIG. 8 Single-Shaft Supercharger Embodiment

FIG. 8 shows a system that uses a bottoming cycle to drive a supercharger for a combustion turbine. The bottoming cycle 23 is the same as described earlier for FIG. 3. The difference is that a second output shaft 306 is connected through a speed-reducer 302 and a shaft 304 to a supercharging fan 300. The supercharging fan 300 is preferably a variable-pitch, axial-flow fan that allows the pitch of the fan blades 310 change so as to vary the fan output pressure. The fan would normally supply 40 to 90 inches of pressure rise and would be a one or two-stage design. The rotating speed is typically about 900 to 1200 rpm. TLT-Babcock or Howden are examples of manufacturers who can supply this type of fan.

A second fogger 320 cools ambient air 308 as it is drawn into and through the supercharging fan. The second fogger is of similar design to the fogger 40. It comprises a source of water 321, which flows to pumps 322 and headers 324 to nozzles 326 to create a fine mist 328. The amount of mist produced should be sufficient to approximately saturate the air entering the combustion turbine. Additional water mist may be provided to act as “overspray” to further enhance performance of the combustion turbine 62 by cooling the air as it flows through the compressor 66. The source of water is preferably demineralized and filtered to prevent possible problems with corrosion and mineral build up inside the combustion turbine 62.

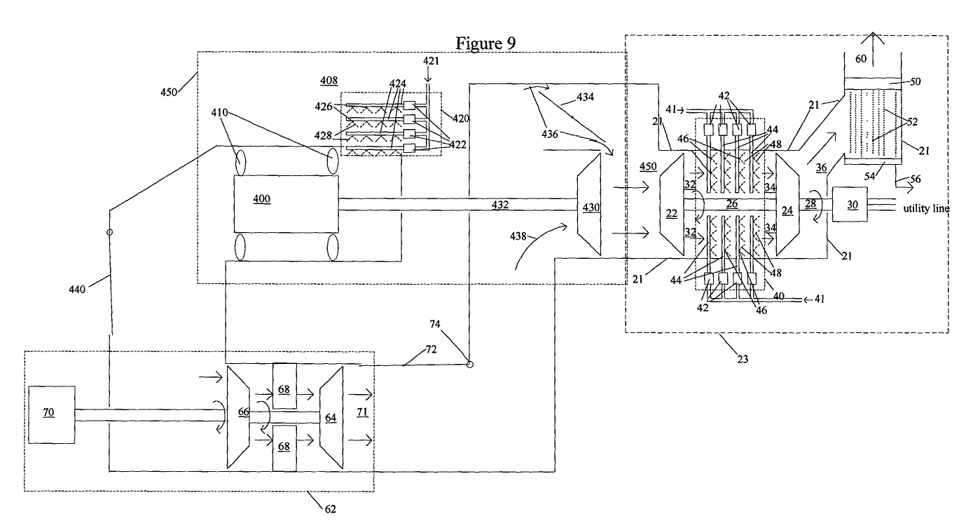

FIG. 9—Preferred Variable-Speed Supercharger Embodiment

FIG. 9 shows a preferred supercharging embodiment that includes a turbine-driven supercharger 450. This turbine-driven supercharger 450 comprises a fogger 420 and a supercharging fan 400 that supply cooled pressurized air to the combustion turbine 62, which was described earlier. The fogger comprises a source of water 421, which is supplied to pumps 422 that pump the water through headers 424 and spray it through nozzles 426 to form a mist 428. This fogger cools air from the atmosphere 408 that enters the power plant. The exhaust 71 from the combustion turbine 62 is divided into two streams. A first stream 438 is supplied to an expander 430 that drives the supercharging fan by way of a shaft 432. A second stream 436 flows through a bypass damper 434. The two streams mix together to form a hot gas stream 450 before entering the bottoming cycle 23, which was described in FIG. 3.

The position of the bypass damper 434 controls the operation of the expander 430 and the supercharging fan 400. For maximum pressure output from the supercharging fan, the bypass damper 434 is closed, which directs the full volume of gas through the expander 430. On the other hand, opening the bypass damper 434 completely allows the full flow to bypass the expander, which effectively stops the supercharging fan 400. A pressure-responsive damper 440 would then open to allow air to the combustion turbine 62 with a minimum of pressure drop. As with the earlier embodiments, the damper 72 can be moved to divert exhaust gas 71 to the atmosphere instead of flowing to the bottoming cycle 23. Modulating the position of the bypass damper 434 would preferably compensate for changes in ambient temperature to allow the combustion turbine to maintain a flat output.

While not preferred for most applications, the turbine-driven supercharger 450 may be installed without the bottoming cycle. An important concern with this approach is that it raises both the turbine inlet and outlet pressures, which may overload components within the combustion turbine 62. For high-altitude applications, the atmospheric pressure is below the normal design value, which means that pressures may rise significantly without causing problems. This set up can increase turbine capacity and efficiency.

While a bypass damper 434 is preferred on the basis of simplicity and ease of operation, other control means are possible. For example a variable-speed turbine many provide variable pressure and flow and recover a significant amount of energy. Variable-pitch blades or variable inlet vanes and also be used a change the supercharging fan and expander output. Yet another approach is to simply adjust the amount of water fog added to the supercharging fan so as to vary the temperature and moisture content of air entering the combustion turbine 62. Combinations of these approaches are also possible.

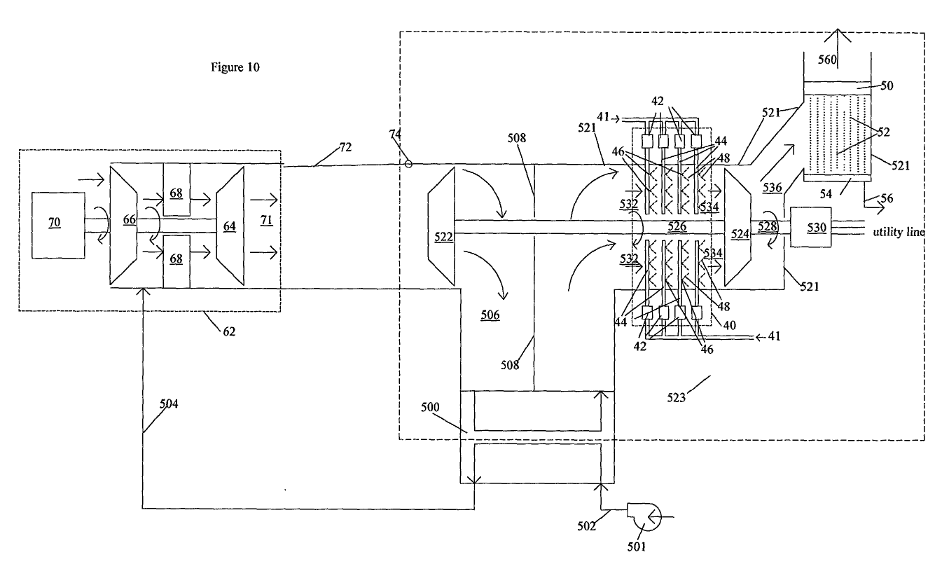

FIG. 10—Team-Injection Embodiment

FIG. 10 shows a steam-injection embodiment. The basic idea is that the exhaust gas 71 from the combustion turbine 62 flows through a bottoming cycle 523 that includes a heat-recovery boiler 500 that produces steam. A pump 501 supplies a stream of demineralized water 502 that boils in the boiler 500 to make stream of steam 504 that exits the boiler 500 and is injected into the combustion turbine 62 between the compressor 66 and the combustor 68. The steam may be mixed with the fuel instead of the air stream as an alternate configuration.

The exhaust gas 71 is a hot gas stream that exits the combustion turbine and enters an expander 522 that is part of the bottoming cycle 523. The expander 522 drives a compressor 524 and a generator 530 by way of a shaft 526 and an output shaft 528.

The expander 522 reduces the pressure of the hot gas to produce a low-pressure gas stream 506. A baffle 508 directs the low-pressure gas stream 506 through the boiler 500 to form a boiler outlet gas stream 532, which enters the fogger 40. The fogger further cools and humidifies the gas stream to create cooled low-pressure gas stream 534. The compressor 524 pressurizes the cooled low-pressure gas stream 534 to form a pressurized gas stream 536 that flows through the mist eliminator 50, which removes water droplets. The gas the exits as an exhaust gas stream 560. A housing 521 directs the gas through the various components in the bottoming cycle 523.

For applications where demineralized water is expensive or in limited supply, it is possible to condense water from the gas stream to reduce water needs. From an efficiency perspective, the optimum location for a heat exchanger is between the heat recovery boiler 500 and the compressor 524. Condensation at this location reduces the volume of the gas entering the compressor and thus improves the efficiency of the bottoming cycle. Another suitable location is in the exhaust stream, which has higher water vapor pressure, but condensation at that location does not affect plant efficiency. The preferred heat exchanger is an indirect evaporative cooler that can cool the gas stream to a temperature approaching the ambient wet-bulb temperature, but other cooling systems are possible if water is in short supply.

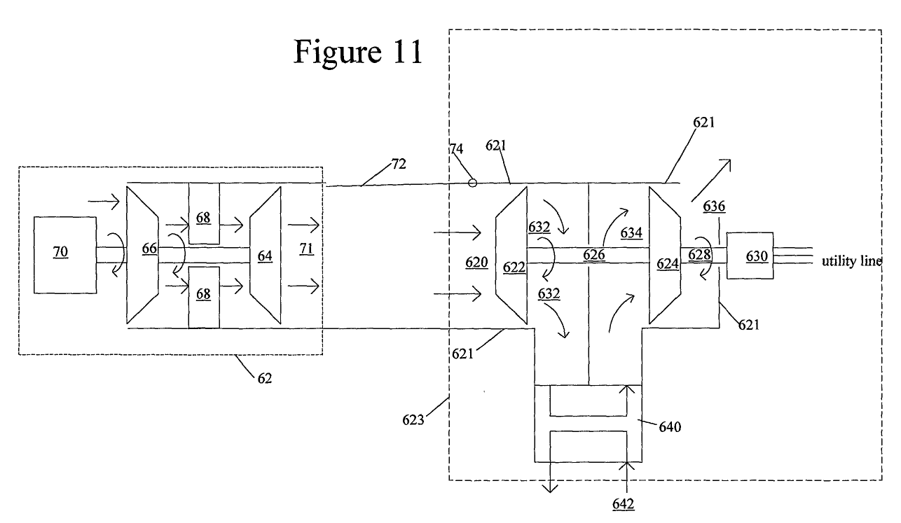

FIG. 11—Air-Cooled Embodiment

FIG. 11 shows an embodiment that is suitable for applications with limited supplies of suitable water. The combustion turbine 62 supplies the exhaust stream 71 to a bottoming cycle 623. As with other embodiments, the damper 74 can divert the exhaust stream 71 to the atmosphere to allow operation of the combustion turbine without the bottoming cycle.

The bottoming cycle 623 comprises an expander 622 that is connected to a compressor 624 by a shaft 626. An output shaft 628 from the compressor drives a generator 630. A heat exchanger 640 cools gas in the bottoming cycle.

The exhaust gas stream 71 from the combustion turbine 62 enters the bottoming cycle as a hot gas stream 620. The hot gas stream 620 drives the expander 622 and leaves the expander as a low-pressure gas stream 632. The low-pressure gas stream 632 is cooled in the heat exchanger 640 by a cooling fluid 642. The cooling fluid may be air from the atmosphere, water from a wet or dry cooling tower, surface water, well water, etc. A cooled low-pressure gas stream 634 exits the heat exchanger and enters the compressor 624, which pressurizes the gas back to atmospheric pressure to form an exhaust gas stream 636 that is vented to the atmosphere. A housing 621 acts as a duct to direct the gas through the bottoming cycle.

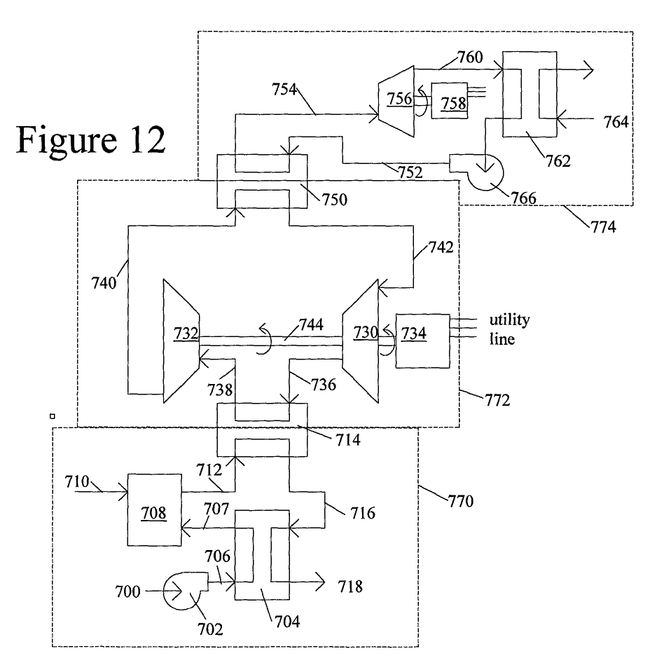

FIG. 12—Closed-Cycle Embodiment

FIG. 12 shows an embodiment with a closed-cycle that is suitable as a topping cycle for coal-fired steam plants. A combustion system 770 supplies thermal energy to a topping cycle 772, whose waste heat drives a steam cycle 774. The combustion system 770 comprises a preheater 704, a burner 708, and high-temperature heat exchanger 714. A fan 702 draws ambient air 700 and a pressurized air stream 706 to the preheater 704. A combustion air stream 707 enters the burner 708 and reacts chemically with a fuel 710 to form a hot combustion gas stream 712. The hot combustion gas stream 712 transfers heat to the topping cycle 772 and leaves the high-temperature heat exchanger 714 as a cooled combustion gas stream 716. The cooled combustion gas stream 716 warms the incoming combustion air in the preheater 704 and exits as an exhaust stream 718.

The topping cycle 772 comprises a fluid circuit formed by the high-temperature heat exchanger 714, an expander 732, a compressor 730, and a steam generator 750. Starting with the high-temperature heat exchanger 714, a pressurized gas stream 736 is warmed to form high-temperature gas stream 738. The high-temperature gas stream 738 flows through the expander 732 to form a low-pressure gas stream 740. The low-pressure gas stream transfers heat to water to form steam in the steam generator 750 and is thereby cooled to create a cooled low-pressure gas stream 742. The compressor 730 raises the pressure of the cooled low-pressure gas stream to make the pressurized gas stream 736, which returns to the high-temperature heat exchanger 736 to complete the fluid circuit. The compressor 730 and the expander 732 are mechanically connected to a common shaft 744 that drives a generator 734 to remove useful power from the topping cycle 772.

An important feature of the topping cycle 772 is that the pressurized gas stream flowing through the high-temperature heat exchanger 714 is at close to atmospheric pressure, which greatly reduces the material strength requirements compared to previous attempt to create a workable topping cycle. This feature also implies that the pressure of the low-pressure gas stream exiting the expander is preferably below atmospheric, in order to achieve a reasonable pressure ratio and cycle efficiency.

The topping cycle must be designed for high-temperature operation in order to achieve good efficiency. The high-temperature heat exchanger is preferably constructed of ceramics or other high-temperature material. The expander should make use of special high-temperature blade materials and cooling systems developed for conventional combustion turbines. These features should allow the temperature of gas entering the expander to exceed 2000° F.

Since the topping cycle is a closed circuit, there is large degree of flexibility in selecting the gas used in the cycle. Relatively inert gases such as helium, nitrogen, argon, etc. may be selected to reduce or eliminate corrosion. Gases with a low molecular weight such as hydrogen, helium, or even superheated steam have the advantage of high heat transfer coefficients compared to air. Use of air has the advantage of essentially zero cost and having properties that are unaffected by leaks to or from the atmosphere. The optimum selection of a working fluid would require a careful consideration of the economics and efficiencies of the possible alternatives.

The steam cycle 774 is a conventional Rankin cycle that comprises a fluid circuit formed by a steam generator 750, a steam turbine 756, a condenser 762, and a feed-water pump 766. The feed-water pump supplies a high-pressure water stream 752 to the steam generator 750, which produces a high-pressure steam stream 754. The high-pressure steam expands through the steam turbine 756 to produce work that allows the steam turbine to drive a generator 758. A low-pressure steam stream 760 leaves the steam turbine and condenses in the condenser 762 and returns as liquid water to the feed-water pump 766 to complete the circuit. Cooling water 764 removes heat from the condenser 762.

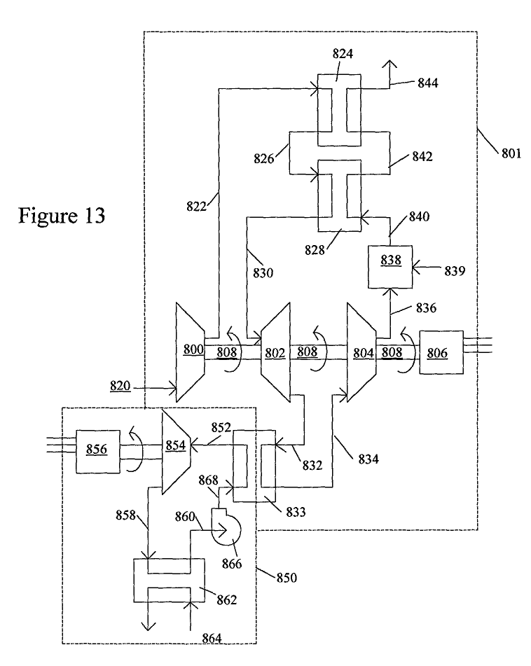

FIG. 13—Preferred Embodiment for a Topping Cycle for Solid-fuel Plants

FIG. 13 shows a preferred embodiment for use with coal, wood, agricultural waste, residual oil or similar fuels produce large amounts of ash and are unsuitable for conventional combustion turbines. The basic configuration is a topping cycle 801 that supplies heat to conventional steam cycle 850. The topping cycle 801 comprises a precompressor 800, an expander 802, and main compressor 804 that are mounted on a common shaft 808 and drive a generator 806. The precompressor 800 draws air from the atmosphere 820 and pressurizes it to form a pressurized air stream 822. The pressurized air flows through a preheater 824, which heats the air to form a preheated air stream 826, which then enters a high-temperature heat exchanger. The high-temperature heat exchanger further heats the air to create a high-temperature air stream 830 that then expands through the expander 802 to a subatmospheric pressure to form a low-pressure air stream 832. The low-pressure air stream transfers thermal energy to the steam cycle 850 by way of a boiler 833 to create a cooled, low-pressure air stream 834.

The main compressor 804 pumps the cooled, low-pressure air stream to a pressure that is nearly atmospheric to make a combustion air stream 836 that enters a combustor 838. The combustor 838 receives a fuel 839 and bums the fuel with the combustion air to produce a high-temperature gas stream 840. The high-temperature gas stream flows through the high-temperature heat exchanger 828 where it heats the preheated air stream 826. The combustion gasses leave the high-temperature heat exchanger as a cooled gas stream 842 that then enters the preheater 824. The preheater transfers thermal energy from the combustion gasses to the pressurized air stream 822. The combustion gasses exit the preheater as an exhaust gas stream 844.

The steam cycle comprises the boiler 833, a steam turbine 854, and condenser 862 and a feed-water pump 866. The feed water pump 866 supplies high-pressure water 868 to the boiler 833, which boils the water to form high-pressure steam 852. The high-pressure steam 852 expands through the steam turbine 854 to create low-pressure steam 858, which is condensed in condenser 862. The condenser is cooled by cooling water 864, which may be drawn from a cooling tower or a natural body of water such as river or lake. Low-pressure water 860 leaves the condenser and returns to the feed-water pump 866 to complete the cycle. The steam cycle may also include economizers, feed-water heaters, superheaters, multiple steam pressures, etc. as found in the prior art of steam cycles.

A key feature of this embodiment is the high-temperature heat exchanger 828 operates with a very small pressure difference compared to heat exchangers in the prior art. High-temperature materials such as ceramics or special metal alloys have limited strength a high-temperature conditions. In conventional steam cycles, heat transfer occurs between high-pressure steam at roughly 1000 psia or higher pressure and gases at nearly atmospheric pressure. Prior attempts to create a gas-turbine cycle have also used a large pressure difference, typically over 100 psi. These pressure differences combined with the very limited strength available from inexpensive ceramic materials at high temperatures, have severely limited the operating temperatures and efficiencies of systems in the prior art. The present invention operates with much smaller pressure differences (on the order of 0.1 to 15 psi), which should greatly reduce cost while allowing for higher-temperature operation of the heat exchanger.

While the pressure difference is small in the high-temperature heat exchanger, the pressure of the clean air stream is preferably higher than that of the combustion gases. This pressure difference ensures that any leakage is from the air stream to the combustion gasses, which prevents contamination of the air.

The design of the heat exchangers and expanders in the embodiments in FIGS. 12 and 13 require special design for the high operating temperatures. The turbine blades in the expanders require the use of special high-temperature alloys and cooling system similar to those used in the prior art for gas turbine blades. The high-temperature heat exchanger would preferably use ceramic materials that can withstand operating temperatures in excess of 2000 degrees F and exposure to combustion gases. Examples of possible ceramic materials include alumina, silica, and silicon carbide, but other materials may be considered depending on cost, availability, material properties, etc. Special, high-temperature metal alloys are also an option for the heat exchangers but are not preferred because of their high cost.

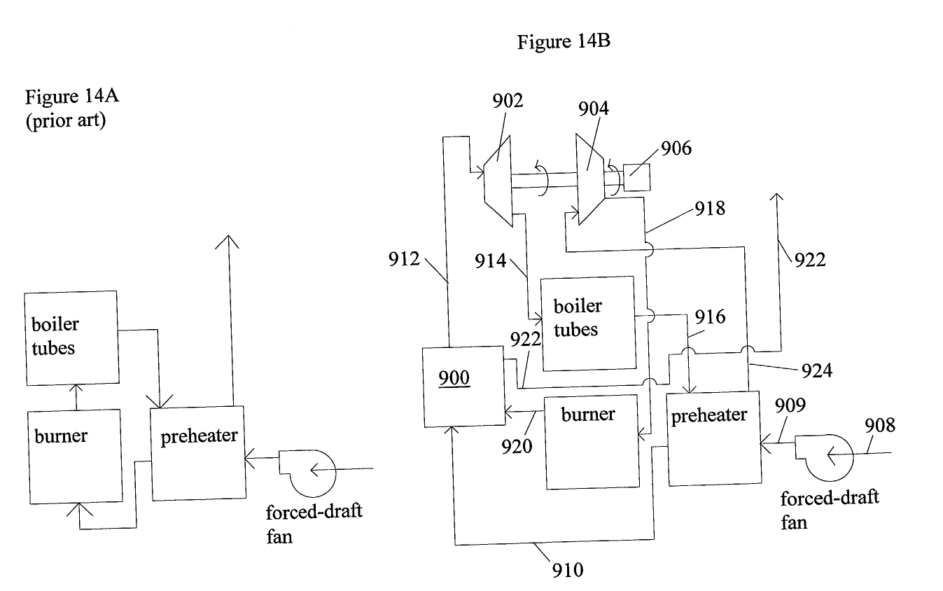

FIGS. 14A and 14B—Topping Cycle Retrofit

FIGS. 14A and 14B show how an existing boiler may be modified to accept the topping cycle in FIG. 13. FIG. 14A is a diagram of a typical coal-fired boiler assembly found in the prior art. A forced draft fan blows air through a preheater that recovers heat from combustion gasses. The burner burns coal to heat the air further. Boiler tubes transfer the heat to make steam for the steam cycle.

FIG. 14B shows the modifications necessary to introduce the topping cycle. Ambient air 908 is blown by the existing forced-draft fan to make a pressurized air stream 909, which enters the preheater. The preheater heats this air to form a preheated air stream, which then enters a high-temperature heat exchanger 900. A high-temperature air stream 912 exits the high-temperature heat exchanger 912 and enters an expander 902, which expands the air to a subatmospheric pressure to make a low-pressure air stream 914. The low-pressure air stream 914 flows over the existing boiler tubes to make steam. A low-pressure air stream 916 exits the boiler is further cooled in the preheater to form cooled low-pressure air stream 924 and is then pressurized through a main compressor 904. The main compressor 904 and the expander 902 share a common shaft and drive a generator 906. A combustion air stream 918 exits the main compressor enters the existing burner. A hot combustion gas stream 920 enters the high-temperature heat exchanger and exits as a cooled combustion gas stream 922, which is then exhausted to the atmosphere.

This figure shows how the topping cycle can be incorporated in to an existing steam generator system. The main changes are related to changing or adding ducts and baffles to direct gas as required for the topping cycle. Another important change is that walls around the boiler tubes will normally need re-enforcement since interior pressure is significantly below atmospheric. (3 to 10 psia is a reasonable range.)

Operation-General Principles

The basic approach of the present invention is opposite that of gas turbines in the prior art. Specifically in conventional gas turbine, gas is compressed, then heated and expanded. Heating the gas increases its volume, which means that work extracted from the expansion process exceeds that from work input for the compression.

In the present invention, on the other hand, hot gas is expanded to a pressure below atmospheric, then cooled and compressed. Cooling the gas reduces its volume, which means the compression process takes less energy than the expansion. The result is a net power output.

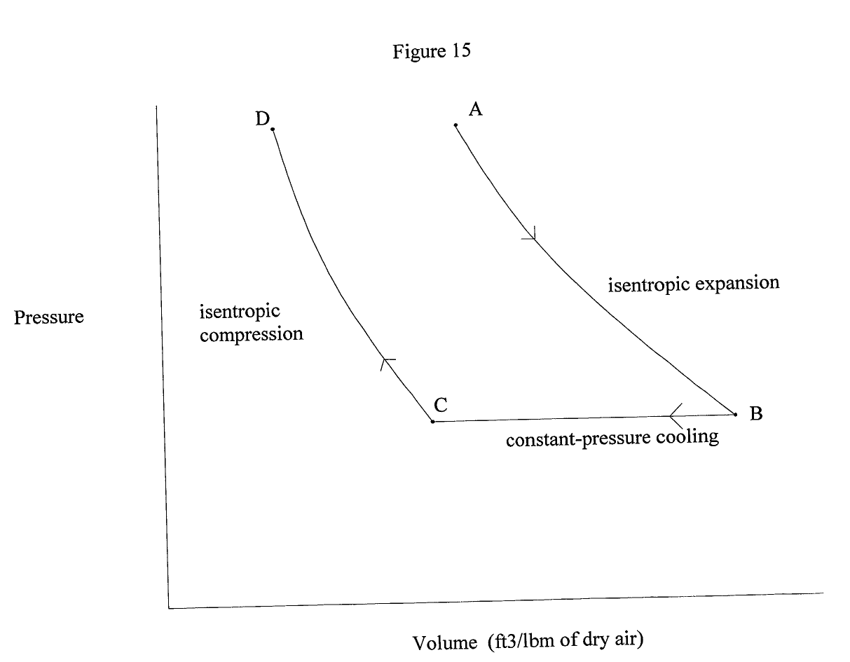

FIG. 15 shows an idealized cycle. Hot gas enters the cycle at point A and is expanded isentropically to point B. The gas is then cooled to point C and compressed back to point D. Points A and D would normally be near atmospheric pressure, while points B and C are below atmospheric pressure.

Operation—Bottoming Cycle (FIGS. 3, 4, and 11)

A preliminary analysis of a bottoming cycle as shown in FIG. 3 shows that the maximum output per unit volume of low-pressure gas occurs with a pressure ratio of about three, which corresponds to a minimum pressure of about 5 psia. Peak efficiency occurs at significantly higher pressure ratios. The optimum value depends on the cost of the expander and compressor and other components compared to the cost of fuel and the price for electricity. A reasonable range of minimum pressures is roughly 2 to 5 psia.

At 3 psia operating pressure the bottoming-cycle efficiency is approximately 14% (assuming 87% efficient compressor and 89% efficient expander). For a 35% efficient base combustion turbine, the bottoming cycle would increase the system efficiency to 44%. This performance corresponds to a 20% increase in both capacity and efficiency of the system compared to the base turbine.

Operation—Steam Injection Embodiment (FIG. 10)

The steam-injection embodiment should further improve the efficiency of the system. Specifically, the steam generator would cool the low-pressure gas. In addition, the steam that is produced further adds capacity to the combustion turbine, which also means that the available energy for the bottoming cycle increases. System efficiency and capacity comparable to those for combined cycle plants should be possible with careful optimization of the component sizes and operating conditions. The steam injection can also significantly reduce NOₓ emissions by controlling peak flame temperatures in the burner.

Operation—Supercharger (FIGS. 8 and 9)

The supercharger system can provide a major boost in both efficiency and capacity compared to conventional simple-cycle combustion turbines. Since turbine capacity drops at a rate of about 0.4% per ° F., the capacity of a combustion turbine is normally about 15% less at 100° F. than at the nominal rating point of 59° F. The generator and transmission system are frequently sized to handle output at winter conditions, which means the maximum capacity is significantly above the nominal rating. For retrofit on an existing combustion turbine, the preferred supercharging fan size would allow the combustion turbine to maintain its peak capacity at summer peaking conditions. The fogger reduces the temperature of the air exiting the supercharging fan.

The output of a typical combustion turbine increases at a rate of about 0.4% per inch of water of inlet pressure rise. Unfortunately the fan also raises the air temperature by about 0.5° F. per inch of water pressure rise, which offsets much of the advantage from the higher operating pressure. The fogger provides evaporative cooling, which reduces the air temperature and further increases power output. These considerations correspond to a maximum supercharging pressure of about 40 to 90 inches of water, which gives a 15 to 30% increase in net power output including the power required to drive the supercharging fan.

At lower ambient temperatures, the supercharger should modulate its output to prevent overload of the generator, electrical transmission system or other critical components. One approach is to reduce the amount of fogging and thereby increase the inlet air temperature. A more efficient approach is to reduce the supercharging pressure through the use of variable-pitch fan blades, variable-speed control, or other means.

The supercharger works in combination with the bottoming cycle to give a large performance enhancement. For example, a 20% supercharger capacity enhancement combined with a 20% increase from the bottoming cycle give a total increase of 44% (1.2×1.2=1.44).

Operation—Stand-alone Engine (FIG. 5)

The stand-alone engine in FIG. 5 is suitable for use in small turbines. In contrast to conventional small gas turbines, the operating pressures are much lower for the same pressure ratio. The difference between the present invention and the conventional turbine is directly proportional to pressure ratio. For example a pressure ratio of four means the peak pressure in the conventional system is four atmospheres, while the maximum pressure in the present invention stays at atmospheric pressure.

The lower operating pressures significantly reduce the required operating speed and increase the size of the expander and compressor, which can significantly improve efficiency. For the same tip speed, increasing the volumetric flow by a factor of two corresponds to doubling the diameter and halving the rotational speed. The lower speed reduces bearing losses. The larger diameter eases the necessary machining tolerances and increases the Reynolds number, both of which act to improve efficiency and reduce cost. Since the net output of combustion turbine is the expander output less the compressor input, improvement of a few points in expander and compressor efficiency can produce a much larger increase in the net output. These advantages are especially important for microturbines with capacities of less than 100 kW because of the extremely small size, high operating speeds, and relatively poor base efficiency.

Operation—Topping Cycle (FIGS. 12, 13, and 14)

The topping cycle offers an opportunity to create a large improvement in efficiency and capacity of coal-fired steam power plants. Coal fired plants efficiencies that are comparable to those for simple-cycle combustion turbines, but there is currently no practical way of improving their efficiency above about 40%. A topping cycle with a pressure ratio of five and an inlet temperature of 2060 F., can achieve an efficiency of over 27%.

An important feature is that the waste heat from the topping cycle drives the conventional steam cycle. For a boiler efficiency of 90% and a steam cycle efficiency of 40%, base plant efficiency is 36%. With a topping cycle, the net output of the system increases to 51%. This efficiency is comparable to that of current combined-cycle plants, and represents an improvement of almost 30% in heat rate.

Operation—Effect of Evaporative Cooling on Gas Volume

To illustrate the volume change that is possible consider the following case at 5 psia:

| | | | | | | Total |
|---|---|---|---|---|---|---|
| | | Mass | Mass | Volume | Volume | Volume |
| | T | of | of | of | of Water | of |
| | (deg F.) | air | Water | Air | Vapor | Mixture |
| Before | 1000 | 1 | 0 | 115 | 0 | 115 |
| evaporation | | | | ft3/lbm | | ft3/lbm |
| After | 130 | 1 | .20 | 46 | 15 | 61 |
| Evaporation | | | | ft3/lbm | ft3/lbm | ft3/lbm |
| | | | | | of dry air | of dry air |

This table shows that the evaporation of water into a stream of hot air can produce a large reduction in volume. Sensible cooling of the gas stream before evaporation of water can further reduce the volume of vapor added to the gas stream and helps to improve the efficiency of the cycle.

Conclusion

Unique Features of the Present Invention:

A unique feature of the present invention is its ability to use waste heat from a gas stream without a heat exchanger. Conventional steam systems or gas turbines in the prior art all require the heat transfer from a hot gas stream at atmospheric pressure to a high pressure fluid. In contrast the present invention, when used with a fogger or other evaporative cooler can provide a means for extracting useful work from a hot gas stream without a heat exchanger.

Innovative Use of Evaporative Cooling:

Another unique feature is the use of a fogger or other means of evaporating water as way of reducing the volume of a hot gas stream. In the prior art of steam-injection gas turbines and steam engines, the conventional approach is to evaporate water to create an increase in fluid volume. Thus the present invention uses evaporation of water to opposite effect.

Advantage of wet compression:

The present invention can make full use of wet compression to reduce compressor work input and improve system efficiency. The system creates a mist of water that is partially evaporated in the compressor, which cools the gas stream and reduces its volume. This feature means that the compression process more closely approximates an isothermal compression. The compressor design should take into account the reduced volumetric flow rate at the higher stages associated with wet compression.

Summary of Advantages:

1) a bottoming cycle that does not need a heat exchanger,

2) high efficiency through efficient use of available temperature differences,

3) low installed cost with the elimination of expensive heat exchangers,

4) low operating cost by eliminating the need for expensive demineralized water in many embodiments,

5) small size compared to conventional combined cycle plants,

6) easy addition of a bottoming cycle to existing power plants,

7) ability to enhance capacity of existing power plants through the addition of a bottoming cycle or a topping cycle,

8) low material cost associated with lower operating temperatures and/or pressures,

9) reduced operating speed and pressures for small turbines for improved efficiency,

10) reduced emissions of atmospheric pollutants such as NOₓ, SOₓ with fogger that acts as a scrubber and from reduced NOₓ formation, and

11) topping cycle for improved efficiency of plants using solid fuel.

Overall this invention represents a major advance in the design of power plants.

Although the description above contains many specificities, these should not be construed as limiting the scope of the invention but merely as providing illustrations of some of the presently preferred embodiments. Numerous variations beyond those shown here are possible and may be desirable for particular applications. For example, turbines with multiple shafts can replace the single-shaft designs as illustrated in the figures. Evaporative pads, an indirect evaporative cooler, or other cooling device may be substituted for foggers. In addition to electrical power generation, the output power from the systems may be used to drive compressors, used to propel locomotives or ships or vehicles, or used for other purposes.

Thus the scope of the invention should be determined by the appended claims and their legal equivalents, rather than by the examples given.

1) An engine comprising:
a) a hot gas stream;
b) an expander that receives said hot gas stream, expands the gas to a pressure below atmospheric to produce a low-pressure gas stream, and extracts work from the expanding gas;
c) means for reducing the temperature of said low-pressure gas stream to produce a cooled, low-pressure gas stream; and
d) a compressor that receives said cooled, low-pressure gas stream and pressurizes it to create a compressed-gas stream.

2) The engine of claim 1 wherein at least a portion of said compressed-gas stream is exhausted to the atmosphere.

3) The engine of claim 2 wherein said means for reducing the temperature of said low-pressure gas stream comprises an evaporative cooler.

4) The engine of claim 3 wherein said evaporative cooler comprises means for injecting a mist of water into said low-pressure gas stream.

5) The engine of claim 4 wherein the amount of water injected is more than that necessary to saturate the compressed-gas stream exiting the compressor.

6) The engine of claim 5 further compressing a mist eliminator in said compressed-gas stream.

7) The engine of claim 3 wherein said evaporative cooler is an indirect evaporative cooler.

8) The engine of claim 2 further comprising wherein said means for reducing the temperature of said low-pressure gas stream comprises a heat exchanger that cools the gas stream with a fluid.

9) The engine of claim 8 further comprises a combustor that supplies said hot gas stream to said turbine wherein said heat exchanger warms air supplied to said combustor.

10) The engine of claim 2 further comprising a combustion turbine whose exhaust forms said hot gas stream.

11) The engine of claim 2 further comprising a second compressor and a combustor.

12) The engine of claim 1 further comprising:
a) a combustion chamber for burning a solid fuel,
b) a high-temperature heat exchanger that transfers heat from hot gases from said combustion chamber to a stream of air so that hot air leaving said heat exchanger forms said hot gas stream,
c) boiler tubes for a steam cycle that serves as said means for cooling said low-pressure gas stream,
d) a flow path from said compressor so that said compressed gas stream provides combustion air to said combustion chamber.

13) The engine of claim 12 further comprising a preheater that transfers heat between the stream of air before it enters said high-temperature heat exchanger and said low-pressure gas stream after it exits said boiler tubes.

14) A method for extracting work from a hot gas stream comprising:
a) expanding said hot gas stream through a turbine to a pressure below atmospheric to produce a low-pressure gas,
b) cooling said low-pressure gas stream to produce a cooled low-pressure gas stream, and
c) compressing said cooled, low-pressure gas stream to produce a compressed-gas stream.

15) The method of claim 14 further comprising exhausting at least a portion of said compressed-gas stream to the atmosphere.

16) The method of claim 14 wherein said cooling comprises injecting a mist of water into said low-pressure gas stream so as to cool the gas through evaporation.

17) A method for extracting work from a volume of hot gas comprising:
a) extracting work from expanding a volume of hot gas to produce a low-pressure gas,
b) reducing the temperature of said low-pressure gas by evaporation of a volatile liquid to produce cooled low-pressure gas, and
c) compressing said cooled low-pressure gas to produce pressurized gas.

18) The method of claim 17 further comprising exhausting said pressurized gas to the atmosphere.

19) The method of claim 18 wherein said volatile liquid is water.

20) The method of claim 19 further comprising injecting said water in the form of a mist into said low-pressure gas.
